(19) United States
(12) Patent Application Publication
(10) Pub. No.: US 2010/0002625 A1
(43) Pub. Date: Jan. 7, 2010

(54) METHOD OF CONNECTING A CLIENT ON A MOVING CARRIER WIRELESSLY TO ONE OR MORE ACCESS POINTS

(75) Inventor: Ramesh SEKHAR, San Jose, CA (US)

Correspondence Address: SYMBOL TECHNOLOGIES INC / MOTOROLA, INC, ONE MOTOROLA PLAZA, A-6, HOLTSVILLE, NY, 11742, US

(73) Assignee: Symbol Technologies, Inc., Holtsville, NY (US)

(21) Appl. No.: 12/168,461

(22) Filed: Jul. 7, 2008

(51) Int. Cl. H04Q 7/00

(52) U.S. Cl. 370/328

(57) ABSTRACT

A method of connecting a client on a moving carrier wirelessly to any stationary access point in a list of stationary access points in a predetermined order. The method includes authenticating the client to a first stationary access point in the list of stationary access points. The method includes identifying the client as an authenticated client and informing other access points in the list of stationary access points with respect to the authenticated client. The method includes bypassing an authenticating process when establishing network connections between the authenticated client and one of the other stationary access points.

### FIELD OF THE DISCLOSURE

The present disclosure relates generally to establishing wireless connections to a list of wireless access points.

### BACKGROUND

FIG. 1 shows a specific example in which it may be desirable to improve the wireless connections for some fast moving objects. In FIG. 1, a subway train 100 travels along a railway line 400. On the subway train 100, one or more computers are connected to a local area network 180. The local area network 180 can be a wireless local area network (WLAN). On the subway train 100, the local area network 180 is connected to a bridge 150. At any moment, a bridge 150 on the subway train 100 may need to establish a wireless connection with one of the access points (e.g., 401, 402, 403, and 404) such that the computers on the local area network 180 can have access to the Internet or other resources accessible from the access points. When the subway train 100 travels at very high speed, if the distance between two access points is smaller than certain distance, the effective bandwidth or throughput of the wireless connection between an access point and the bridge 150 maybe significantly reduced.

Taking one specific example, assume that the subway train 100 moves at a speed of 30 meters per second (which is close to 100 kilometers per hour) and the distance between two access points is 90 meters, the reduction of the effective data throughput of the wireless connection depends upon several factors. On average, the subway train 100 will spend about three seconds (i.e., 3 seconds) in the vicinity of each access point. To establish a wireless connection with any given access point, the bridge 150 may first need to scan some or all available channels in order to discover the designated wireless channel for connecting to the given access point; subsequently, the bridge 150 may need to authenticate itself to the given access point and exchange keys with the given access point in order to establish the secured connections. If the bridge 150 spends one second (i.e., 1 second) to discover the designated wireless channel and one second (i.e., 1 second) to establish the secured connections, the bridge 150 may left with only one second (i.e., 1 second) for transferring real data packets with the given access point. In this specific example, for every three seconds available only one second is used for transferring real data packets; thus, the effective data throughput of the wireless connection has been reduced by nearly 66%.

In certain design of wireless networks, it may be desirable to reduce the cell size associated with each access point. As the distance between access points reduces, the effective data throughput of the wireless connection between a computer on a fast moving object (e.g., a subway train, or an automobile) and the wireless networks can be significantly reduced. Therefore, it may be desirable to find some new method to improve the effective data throughput of some wireless connections for those fast moving objects.

FIG. 2 shows another specific example in which it may be desirable to improve the wireless connections for some fast moving objects. In FIG. 2, an automobile 100 travels along a freeway 400. At any moment, a cell phone 160 on the automobile 100 may need to establish a wireless connection with one of the access points (e.g., 401, 402, 403, and 404) such that the cell phone 160 can have access to the Internet or other services, such as, voice over Wireless LAN (VoWLAN). In this example, it desirable to improve the effective data throughput of the wireless connections; it is also desirable to minimize the time delays of data packets to improve the voice quality of the cell phone 160, if VoWLAN is used.

### SUMMARY

In one aspect, the invention is directed to a method of connecting a client on a moving carrier wirelessly to any stationary access point in a list of stationary access points in a predetermined order. The method includes authenticating the client to a first stationary access point in the list of stationary access points. The method includes identifying the client as an authenticated client and informing other access points in the list of stationary access points with respect to the authenticated client. The method includes bypassing an authenticating process when establishing network connections between the authenticated client and one of the other stationary access points.

In another aspect, the invention is directed to a method of connecting a client on a moving carrier wirelessly to any stationary access point in a list of stationary access points in a predetermined order. The method includes finding a designated channel for a next stationary access point from the client's local storage. The method includes monitoring the strength of a radio signal in the designated channel for the next stationary access point while the client is maintaining network connection with a current stationary access point based on a designated channel for the current stationary access point. The method includes terminating network connection between the client and the current stationary access point when the strength of a radio signal in the designated channel for the next stationary access point exceeds the strength of a radio signal in the designated channel for the current stationary access point by a predetermined amount. The method includes establishing and maintaining network connection between the client and the next stationary access point base on the designated channel for the next stationary access point.

In another aspect, the invention is directed to a method of connecting a client on a moving carrier wirelessly to any stationary access point in a list of stationary access points in a predetermined order. The method includes finding from a current stationary access point the designated channel for the next stationary access point. The method includes monitoring the strength of a radio signal in the designated channel for the next stationary access point while the client is maintaining network connection with a current stationary access point based on a designated channel for the current stationary access point. The method includes terminating network connection between the client and the current stationary access point when the strength of a radio signal in the designated channel for the next stationary access point exceeds the strength of a radio signal in the designated channel for the current stationary access point by a predetermined amount. The method includes establishing and maintaining network connection between the client and the next stationary access point base on the designated channel for the next stationary access point.

Implementations of the invention can include one or more of the following advantages. The effective data throughput of some wireless connections between a client on a fast moving carrier and a list of stationary access points can be improved. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a specific example in which it may be desirable to improve the wireless connections for some fast moving objects.

FIG. 2 shows another specific example in which it may be desirable to improve the wireless connections for some fast moving objects.

FIG. 3 is a flowchart of a method of connecting a client on a moving carrier wirelessly to stationary access points in accordance with some embodiments.

FIG. 4 is a flowchart of a method of connecting a client wirelessly to stationary access points directly on the corresponding designated channels in accordance with some embodiments.

FIG. 5 is a flowchart showing an implementation of the block 510 in FIG. 4.

FIG. 6 shows another implementation of the method for connecting a client wirelessly to stationary access points directly on the corresponding designated channels.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

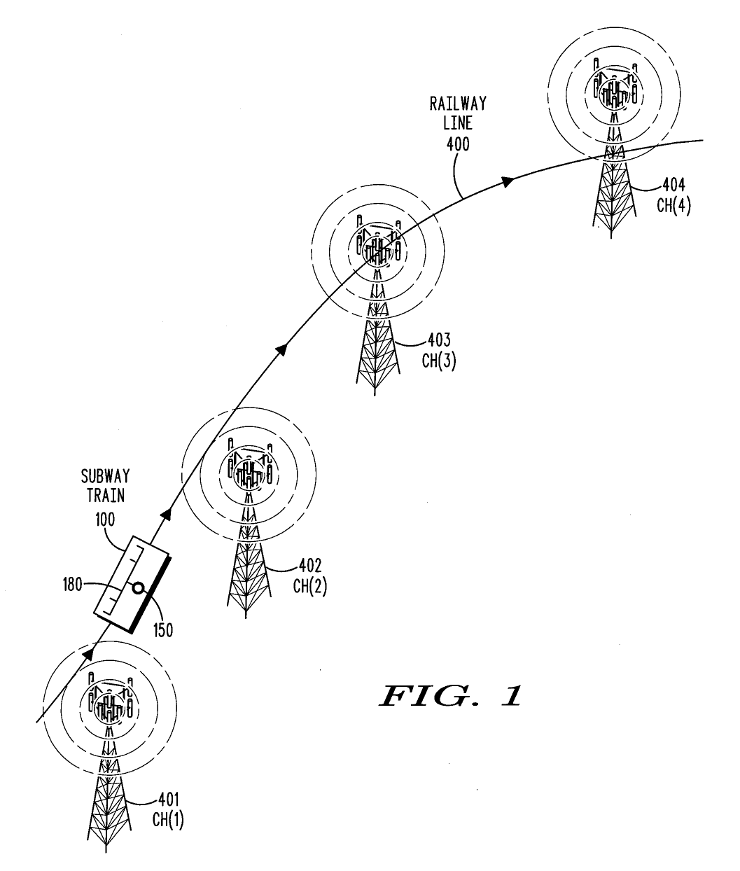

FIG. 3 is a flowchart of a method 300 of connecting a client on a moving carrier wirelessly to stationary access points in accordance with some embodiments. These stationary access points generally are arranged in a predetermined order. For example, as shown in FIG. 1, the moving carrier is a subway train 100, and the stationary access points 401, 402, 403, and 404 can be positioned along the railway 400. The client to be connected to the access points 401, 402, 403, and 404 is the bridge 150 (which is connected to the local area network 180 on the subway train 100). When the subway train 100 moves along the railway 400 in the direction as indicated in the figure, the subway train 100 will moves to the vicinity of each access point in a predetermined order (i.e., in the order of access points 401, 402, 403, and 404). As shown in FIG. 3, the method 300 of connecting a client on a moving carrier wirelessly to stationary access points includes blocks 310, 320, and 330.

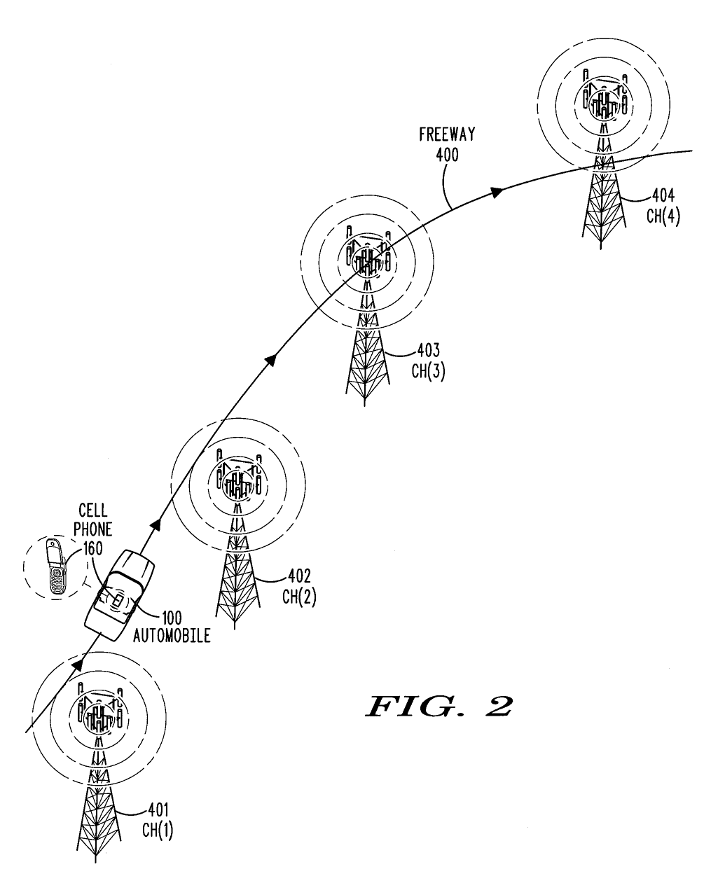

The block 310 includes authenticating the client to a first stationary access point in the list of stationary access points. The block 320 includes identifying the client as an authenticated client and informing other access points in the list of stationary access points with respect to the authenticated client. The block 330 includes bypassing an authenticating process when establishing network connections between the authenticated client and one of the other stationary access points. The client can be a bridge 150 as shown in FIG. 1. The client can also be a cell phone 160 as shown in FIG. 2, or other kinds of computational devices.

In one implementation, as the method 300 is exemplarily applied to the system in FIG. 1, the block 310 in FIG. 3 can include authenticating the bridge 150 to access point 401. Once the bridge 150 is authenticated to the access point 401, the access point 401 can inform other access points (e.g., access points 402, 403, and 404) that the bridge 150 is an authenticated client. For example, the access point 401 can identify the bridge 150 with an identity, and the access point 401 can then inform other access points (e.g., access points 402, 403, and 404) the identity of the bridge 150. The identity of the bridge 150 can be sent to access points 402, 403, and 404 through either a wired connection or a wireless connection. When the subway train 100 moves close to one of the other access points (e.g., access point 402, 403, or 404), this access point can bypass the authenticating process if this access point recognizes that the bridge 150 is an authenticated client. The bypassing of the authenticating process may reduce the time it takes for the bridge 150 to establish secured connections with this access point (e.g., access point 402, 403, or 404). In addition, the time it takes for the bridge 150 to establish secured connections with a given access point can be further reduced if the bridge 150 knows the designated channel used by this access point.

In many current systems, when a client (such as the bridge 150) attempt to establish connections with a given access point, the client (such as the bridge 150) generally needs to scan some or all possible channels that can possibly be used to support a particular protocol. For example, the client (such as the bridge 150) may need to scan three channels if the client want establish a connection with the access point using 802.11b protocol. The client may need to scan eight channels if the client want establish a connection with the access point using 802.11a protocol. It is foreseeable that some of the more advanced protocols may use even more channels. It can be very time consuming to scan all possible channels to find the designated channel used by a given access point. Such a problem can only aggravate as the number of all possible channels increases. On the other hand, if the client (such as the bridge 150) knows the designated channel used by a given access point already, the client can monitor the strength of a radio signal in this designated channel, and when the strength of the radio signal in this designated channel exceeds certain threshold, the client can establish the wireless connection with this given access point directly on the designated channel.

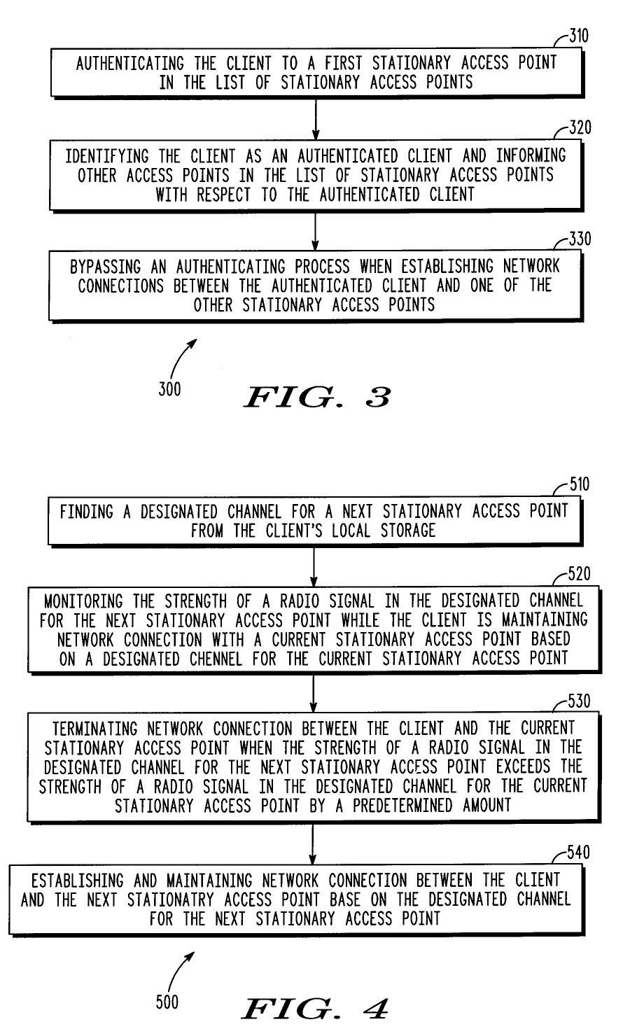

FIG. 4 is a flowchart of a method 500 of connecting a client wirelessly to stationary access points directly on the corresponding designated channels in accordance with some embodiments. The method 500 includes blocks 510, 520, 530, and 540. The block 510 includes finding a designated channel for a next stationary access point from the client's local storage. The block 520 includes monitoring the strength of a radio signal in the designated channel for the next stationary access point while the client is maintaining network connection with a current stationary access point based on a designated channel for the current stationary access point. The block 530 includes terminating network connection between the client and the current stationary access point when the strength of a radio signal in the designated channel for the next stationary access point exceeds the strength of a radio signal in the designated channel for the current stationary access point by a predetermined amount. The block 540 includes establishing and maintaining network connection between the client and the next stationary access point base on the designated channel for the next stationary access point. The client can be a bridge 150 as shown in FIG. 1. The client can also be a cell phone 160 as shown in FIG. 2, or other kinds of computational devices.

In one implementation, as the method 500 is exemplarily applied to the system in FIG. 1, in which the subway train 100 moves along the railway 400. In a scenario that the subway train 100 is positioned between access points 401 and 402, the bridge 150 on the subway train 100 may need to establish a wireless connection with the access point 402 when the subway train 100 moves to the vicinity of this access point. The bridge 150 needs first to find the designated channel for the access point 402 from the client's local storage. In the example as shown in FIG. 1, the designated channel for the access point 402 is channel CH (2). The bridge 150 then can monitor the strength of a radio signal in channel CH (2) while maintaining network connection with the access point 401 based on channel CH(1). When the strength of a radio signal in channel CH (2) exceeds the strength of a radio signal in channel CH (1) by a predetermined amount, the bridge 150 will terminate the network connection with the access point 401; the bridge 150 then establish and maintain a network connection with the access point 402 base on channel CH (2).

FIG. 5 is a flowchart showing an implementation of the block 510 in FIG. 4. In this implementation, the block 510 includes blocks 512, 514, and 516. The block 512 includes learning the designated channel by the client for each stationary access point in the list of stationary access points. The block 514 includes storing in the client's local storage the designated channel for each stationary access point in the list of stationary access points. The block 516 includes finding the designated channel from the client's local storage. The client can be a bridge 150 as shown in FIG. 1. The client can also be a cell phone 160 as shown in FIG. 2, or other kinds of computational devices.

In one implementation, as the block 510 in FIG. 5 is exemplarily applied to the system in FIG. 1, the bridge 150 can learn the designated channel for each access point (e.g., access points 401, 402, 403, or 404) when the subway train 100 moves along the railway 400 from a location close to access point 401 to a location close to access point 404. The bridge 150 can then store this information (i.e., the designated channel for each access point) in a local storage. This local storage can be memory storage on the bridge 150 itself; it can also be memory storage anywhere on the local area network 180. In later subsequent passage, as the subway train 100 moves close to an access point (e.g., access point 403), the bridge 150 can find the designated channel for this access point (i.e., access point 403) from the local storage. Then, the bridge 150 can start to monitor the strength of a radio signal in the designated channel—i.e., channel CH(3) for access point 403—before making wireless connections to this access point.

In another implementation, the block 510 can include blocks 514 and 516 but does not include block 512. The bridge 150 does not have to learn the designated channel for each access point, for example, by making at least one trip traveling along the railway 400. This information (i.e., the designated channel for each access point) can be provided to the bridge 150 from some other independent source.

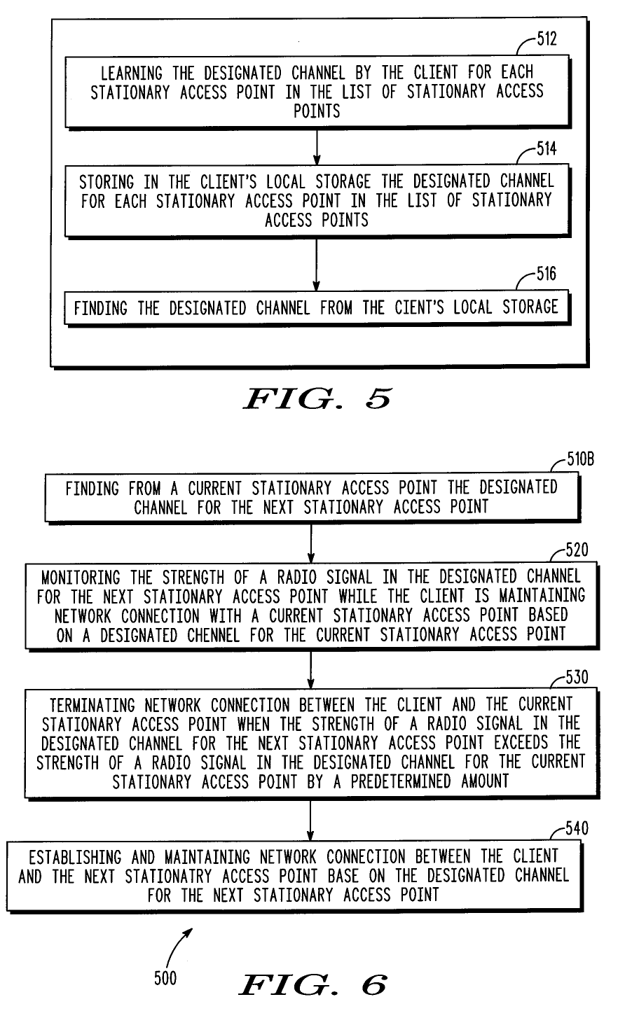

FIG. 6 shows another implementation of the method 500 for connecting a client wirelessly to stationary access points directly on the corresponding designated channels. In this implementation, the method 500 includes blocks 510B, 520, 530, and 540. The blocks 520, 530, and 540 can be identical to the corresponding blocks in FIG. 4. The 510B includes finding from a current stationary access point the designated channel for the next stationary access point. In one implementation, as the method 500 is exemplarily applied to the system in FIG. 1, in which the subway train 100 moves along the railway 400. In a scenario that the subway train 100 is positioned between access points 401 and 402, the bridge 150 on the subway train 100 may need to establish a wireless connection with the access point 402 when the subway train 100 moves to the vicinity of this access point. The bridge 150 needs first to find the designated channel for the access point 402 from the access point 401. In a specific example, the access point 402 can pass the information about its designated channel to the access point 401 through either a wireless connection or a wireline connection; subsequently, the access point 401 can pass this information (about the designated channel for the access point 402) to the bridge 150 when the subway train 100 is in the vicinity of the access point 401 and the bridge 150 is still in wireless connection with the access point 401.

Generally, in the foregoing specification and embodiments described, the client can include an access point severing a wireless local area network on the moving carrier. The client can include a bridge operative to connect wirelessly to a stationary access point. The client can include a bridge connecting a local area network on the moving carrier. The client can include a bridge connecting a local area network comprising a wireless local area network on the moving carrier. The client can include a computer. The client can include a telephone implementing voice over internet protocol. The client can include a telephone implementing voice over Wireless LAN protocol.

Generally, in the foregoing specification and embodiments described, the moving carrier can be a subway train, and the list of stationary access points can be arranged along a railway track on which the subway train travels. The moving carrier can be a motor vehicle, and the list of stationary access points can be arranged along a highway on which the motor vehicle travels. The moving carrier can be an elevator, and the list of stationary access points can be arranged along a path near which the elevator moves.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of connecting a client on a moving carrier wirelessly to any stationary access point in a list of stationary access points in a predetermined order comprising:
authenticating the client to a first stationary access point in the list of stationary access points;
identifying the client as an authenticated client and informing other access points in the list of stationary access points with respect to the authenticated client; and
bypassing an authenticating process when establishing network connections between the authenticated client and one of the other stationary access points.

2. The method of claim 1, wherein the identifying the client as an authenticated client and informing other access points in the list of stationary access points with respect to the authenticated client comprises:
identifying the client with an identity and informing other access points in the list of stationary access points the identity of the client.

3. The method of claim 1, further comprising:
finding a designated channel for a next stationary access point; and
monitoring the strength of a radio signal in the designated channel for the next stationary access point while the client is maintaining network connection with a current stationary access point based on a designated channel for the current stationary access point.

4. The method of claim 3, further comprising:
terminating network connection between the client and the current stationary access point when the strength of a radio signal in the designated channel for the next stationary access point exceeds the strength of a radio signal in the designated channel for the current stationary access point by a predetermined amount; and
establishing and maintaining network connection between the client and the next stationary access point base on the designated channel for the next stationary access point.

5. The method of claim 3, further comprising:
storing in the client's local storage the designated channel for each stationary access point in the list of stationary access points; and
wherein the finding a designated channel for a next stationary access point comprises finding the designated channel from the client's local storage.

6. The method of claim 3, further comprising:
learning the designated channel by the client for each stationary access point in the list of stationary access points;
storing in the client's local storage the designated channel for each stationary access point in the list of stationary access points; and
wherein the finding a designated channel for a next stationary access point comprises finding the designated channel from the client's local storage.

7. The method of claim 1, wherein the finding a designated channel for a next stationary access point comprises:
finding from a current stationary access point the designated channel for the next stationary access point.

8. The method of claim 1, wherein the client comprises an access point severing a wireless local area network on the moving carrier.

9. The method of claim 1, wherein the client comprises a bridge operative to connect wirelessly to a stationary access point.

10. The method of claim 9, wherein the client comprises a bridge connecting a local area network on the moving carrier.

11. The method of claim 9, wherein the client comprises a bridge connecting a local area network comprising a wireless local area network on the moving carrier.

12. The method of claim 1, wherein the client comprises a computer.

13. The method of claim 1, wherein the client comprises a telephone implementing voice over internet protocol.

14. The method of claim 1, wherein the client comprises a telephone implementing voice over Wireless LAN protocol.

15. The method of claim 1, wherein the moving carrier comprises a subway train, and the list of stationary access points are arranged along a railway track on which the subway train travels.

16. The method of claim 1, wherein the moving carrier comprises a motor vehicle, and the list of stationary access points are arranged along a highway on which the motor vehicle travels.

17. The method of claim 1, wherein the moving carrier comprises an elevator, and the list of stationary access points are arranged along a path near which the elevator moves.

18. A method of connecting a client on a moving carrier wirelessly to any stationary access point in a list of stationary access points in a predetermined order comprising:
finding a designated channel for a next stationary access point from the client's local storage;
monitoring the strength of a radio signal in the designated channel for the next stationary access point while the client is maintaining network connection with a current stationary access point based on a designated channel for the current stationary access point;
terminating network connection between the client and the current stationary access point when the strength of a radio signal in the designated channel for the next stationary access point exceeds the strength of a radio signal in the designated channel for the current stationary access point by a predetermined amount; and
establishing and maintaining network connection between the client and the next stationary access point base on the designated channel for the next stationary access point.

19. The method of claim 18, further comprising:
storing in the client's local storage the designated channel for each stationary access point in the list of stationary access points.

20. The method of claim 18, further comprising:
learning the designated channel by the client for each stationary access point in the list of stationary access points; and
storing in the client's local storage the designated channel for each stationary access point in the list of stationary access points.

21. A method of connecting a client on a moving carrier wirelessly to any stationary access point in a list of stationary access points in a predetermined order comprising:
finding from a current stationary access point the designated channel for the next stationary access point;
monitoring the strength of a radio signal in the designated channel for the next stationary access point while the client is maintaining network connection with a current stationary access point based on a designated channel for the current stationary access point;
terminating network connection between the client and the current stationary access point when the strength of a radio signal in the designated channel for the next stationary access point exceeds the strength of a radio signal in the designated channel for the current stationary access point by a predetermined amount; and
establishing and maintaining network connection between the client and the next stationary access point base on the designated channel for the next stationary access point.
